(19) United States
(12) Patent Application Publication
(10) Pub. No.: US 2010/0155584 A1
(43) Pub. Date: Jun. 24, 2010

(54) SENSOR FOR DETECTING DIRT AND/OR RAIN AND METHOD FOR OPERATING A SENSOR

(76) Inventor: Bernd Mack, Remshalden (DE)

Correspondence Address: REISING ETHINGTON P.C., P O BOX 4390, TROY, MI, 48099-4390, US

(21) Appl. No.: 12/642,187

(22) Filed: Dec. 18, 2009

Related U.S. Application Data
(63) Continuation-in-part of application No. 11/854,179, filed on Sep. 12, 2007, now abandoned.

(30) Foreign Application Priority Data
Sep. 13, 2006 (DE) 102006044792.1

(51) Int. Cl. G02B 6/42

(52) U.S. Cl. 250/227.25

(57) ABSTRACT

A sensor detects dirt and/or rain having a transmitter unit (12, 112) and at least one receiver unit (16, 116) as well as a test surface (22, 122), an accumulation (30, 32) on the test surface (22, 122) being detectable by a light beam (24, 26; 124, 126), which is emitted by the transmitter unit (12, 112) and absorbed by the receiver unit (16, 116). The transmitter unit (12, 112) has at least two transmitters (114), at least one of which comprises two or more locally closely adjacent transmission sources (114a, 114b, 114c, 114d), one receiver (18, 118) of the receiver unit (16, 116) being associated with each transmitter (114). The receiver (18, 118) have one or more individual receivers, at least one of the transmitters (114) being implemented for the purpose of emitting at least two different wavelengths, which are detectable by the associated receiver (18, 118).

This patent application is a continuation-in-part of a United States patent application having application Ser. No. 11/854,179, which is hereby incorporated by reference.

### BACKGROUND ART

1. Field of the Invention

The invention relates to a sensor for detecting dirt and/or rain and a method for operating a sensor according to the preambles of the independent claims.

2. Description of the Related Art

Using optoelectronic sensor devices as dirt detectors or rain detectors is known. Such a sensor device typically comprises at least one transmitter unit, which emits testing light, and at least one receiver unit. Contaminants deposited on a test surface influence the intensity of the testing light received by the receiver unit. The transmitter unit typically comprises a semiconductor-based radiation source, which preferably operates in the near infrared range. PIN diodes, which are sensitive over a large wavelength range, are typically used as the receiver.

Rain sensors typically operate on the basis of reflection, a light beam being emitted at a flat angle into the test surface, such as a windshield of a vehicle, and being reflected back by the external boundary layer to the receiver. If dirtying by an opaque medium such as dust lies on the test surface, the reflection properties of the boundary layer glass to air and dust change; in addition, light is absorbed in the dust. The luminosity measured in the receiver decreases. If the light beam is coincidentally incident on a rain drop on the test surface, it can occur that the light beam is completely scattered and intensity is no longer registered in the receiver, which is incorrectly interpreted as 100% dirtying.

Dirt sensors based on transmitted light, as are known, for example, from DE 10 2004 038 422 B3, operate according to the principle of a light barrier. Light passes once or multiple times through a test surface and is then incident on the receiver. The degree of dirtying can be derived from the known emitted intensity and the actually received intensity. With light-opaque dirtying, such as dust, the reduction of the intensity at the receiver is proportional to the degree of the dirtying. With transparent types of dirtying, such as water or oil, the droplets may act as optical elements as described for the rain sensor and may deflect the measuring light beam. Under geometrically unfavorable conditions, for example, if a water droplet is seated directly in the path of the light beam, the receiver receives no intensity and incorrectly recognizes complete dirtying.

In typical rain sensors, for example, in a vehicle, such faulty measurements are accepted; activation of the windshield wiper occurs independently of whether dirt or water is located on the windshield.

If such sensors are used in order to adjust a luminosity of a vehicle light in the event of detected dirtying or perform a check of the function of the sensor, however, such a faulty interpretation of transparent and only briefly adhering water droplets as dirtying similar to dust causes interference.

### SUMMARY OF THE INVENTION

The object of the invention is to disclose a sensor for detecting dirt and/or rain, with which it is possible to differentiate between transparent accumulations, such as water, and light-opaque accumulations, such as dust. Furthermore, a method for operating the sensor is to be disclosed.

The object is achieved by the features of the independent claims. Advantageous embodiments are the subject matter of the further claims.

A sensor according to the invention for detecting dirt and/or rain has at least one transmitter unit and at least one receiver unit as well as a test surface, an accumulation on the test surface being detectable by light emitted by the transmitter unit and absorbed by the receiver unit. The transmitter unit has at least two transmitters, at least one of which comprises two or more closely locally adjacent transmission sources. One receiver of the receiver unit is associated with each transmitter. The receiver or the receivers have one or more individual receivers. At least one of the transmitters is implemented for the purpose of emitting at least two different wavelengths, which are detectable by the associated receiver. In the event of a transparent accumulation, in particular of water droplets, on the test surface, a larger variation of the received light intensity of the different wavelengths is advantageously detectable in the receiver unit than in the event of an accumulation which is opaque in the visible range.

By observing the variation of the light intensity received by the receiver as a function of the wavelength, a differentiation can be made between accumulation which is opaque in the visible range, such as dust, and accumulation which is transparent in the visible range, such as water. Thus, water absorbs radiation above all in the ultraviolet range and longer-wavelength infrared range, so that in the event of a variation of the wavelength of the testing light emitted by the transmitter, the receiver will show relatively strong intensity variations, while it is significantly more transparent to visible light. In contrast, an accumulation such as dust absorbs relatively independently of the wavelength, so that the intensity shown by the receiver only displays a slight variation as a function of the wavelength. A transmitter can be provided which emits in a broadband manner, in particular in the wavelength range in the ultraviolet range up into the longer-wavelength infrared range, or multiple transmitters, in particular based on semiconductors such as light-emitting diodes (LEDs), which each emit nearly monochromatic light, but at different wavelengths. Wavelengths in the range of the ultraviolet, particularly preferably in the range ≦0.3 μm, and in the longer-wavelength infrared range, particularly preferably in the range ≧1 μm, are preferably used. Light is to be understood here as electromagnetic radiation having a wavelength in the range from infrared to ultraviolet, i.e., both in the visible spectrum (VIS) and also outside the visible spectrum. The sensor is advantageously capable of being used in connection with luminosity regulation, with which dirtying of vehicle lights is to be compensated for by an application of the emitted light intensity. An unnecessary and unwanted increase of the light intensity by an incorrect determination of accumulations, in which transparent accumulations in the form of water droplets are confused with opaque accumulations such as dust, can be avoided.

The transmitter unit can advantageously comprise at least two transmitters having different wavelengths. One receiver is associated with each transmitter. Typical LEDs may be used. It is advantageous if at least one of the transmitters comprises multiple transmission sources, which are situated closely adjacent and spatially separate from the closest transmitter. The use of different wavelengths with suitable positioning of the transmission sources can compensate for the geometrical path difference of the light beams, which is caused by the different wavelengths, from the particular transmission source to the shared receiver. Multiple individual receivers may be provided, which form one receiver. A light intensity which is not oriented exactly on one single individual receiver, but rather offset somewhat thereto, can thus also be detected. The sensor is thus robust overall against production tolerances upon the alignment of the transmitter and receiver.

If a water droplet is unfavorably seated on the test surface, for example, directly in the beam path between the transmission sources/the transmitter and the associated shared receiver of the transmission sources/the transmitter, it can occur that the receiver does not receive the intensity of the testing light. A characteristic variation of the signal can be observed at the receiver due to the different wavelengths. Water absorbs in the ultraviolet range and in the infrared range and is transparent in the visible range, so that a variation of the received intensity is to be expected. Slight geometric path differences at different wavelengths can cause a large variation of the received intensity. In contrast, if dust is present as a deposit on the test surface in the beam path, a variation of the light intensity as a function of the wavelength is significantly less or does not exist at all.

A further sensor according to the invention for detecting dirt and/or rain has at least one transmitter unit and at least one receiver unit and a test surface, an accumulation on the test surface being detectable through light emitted by the transmitter unit and received by the receiver unit. The transmitter unit has at least two transmitters, at least one comprising at least two or more locally closely adjacent transmission sources. One receiver of the receiver unit is associated with each of the transmitters. Each receiver has one or more individual receivers. The testing light emitted by the transmitter advantageously causes a larger variation of the received light intensity in the receiver of the receiver unit which is associated with the particular transmitter in the event of accumulation of a transparent water droplet on the test surface than in the event of accumulation of a light-damping contaminant.

The receiver associated with the transmitter can advantageously comprise a group of single, closely adjacent individual receivers. If the transmitter has multiple transmission sources, the receiver is the shared receiver for the transmission sources of the transmitter. The transmission sources may operate either at the same wavelength or also at different wavelengths. Through the spatial offset of the transmission sources and/or the individual receivers to one another, a water droplet seated in a geometrically unfavorable manner on the test surface can be recognized, because it is typically locally bounded and thus even a slight change of the beam path, i.e., the path length of the light radiation between transmitter and receiver, can already suffice to cause a significant variation in the intensity of the received signal in the receiver. The sensor is advantageously capable of being used in connection with a luminosity regulating device, in which dirtying of lights is to be compensated for by an amplification of the emitted light intensity. An undesired increase of the light intensity due to confusion of accumulations of transparent water droplets with light-opaque or light-damping accumulations of dirt can be avoided.

If the light beams emitted by the transmitters additionally have different wavelengths, this variation in the intensity of the received signal in the receiver can still be amplified in combination with the spatial offset of the transmission sources in one or more transmitters. The spatial offset is such that the receiver can reliably receive signals of the associated transmitter and/or the transmission sources associated with the transmitter, even if they have slightly different optical paths from the transmitter to the receiver due to the offset of the transmission sources. This can advantageously be caused in that the transmission sources of the transmitter are situated on a closely bounded region, whose area approximately corresponds to the area of the number of the transmission sources, and is preferably at most five times as great, particularly preferably at most three times as great. The area is preferably bounded so that the shared receiver of the transmission sources of the transmitter can receive their individual signals. Adjacent transmitters and/or receivers are reliably separated from one another.

An embodiment of the sensor as a transmitted light sensor is preferred. Such a sensor is particularly suitable as a dirt sensor.

An embodiment of the sensor as a reflection sensor is also preferred. Such a sensor is particularly suitable as a rain sensor.

An analysis unit can expediently be provided, in order to analyze a wavelength-dependent intensity variation of the received light beams and/or a location-dependent intensity variation of the received light beams, such as a computer unit having processor unit and storage unit, using which signals of the receiver or receivers of the receiver unit may be analyzed as a function of the emitted wavelength and/or the geometrical position of the transmission sources of the transmitter or transmitters. In particular, intensities which were determined at a first wavelength may be compared to intensities which were determined at another or multiple other wavelengths. Additionally or alternatively, signals of the receiver, in particular of individual receivers of each single receiver which has the individual receivers, may be evaluated.

The analysis unit can expediently be combined with a control or regulating unit for an adaptive luminosity adjustment in a vehicle. If both wavelength-dependent and also location-dependent signals are to be analyzed, this can be performed using a shared analysis unit.

The transmitter unit can preferably comprise light-emitting diodes as the transmitter and/or as the transmission sources. The light-emitting diodes preferably emit nearly monochromatic light, so that, for example, an examination as a function of various wavelengths is simple to implement.

Alternatively, the transmitter unit can comprise at least one broadband transmitter. In this case, it is particularly expedient if the receiver unit comprises a band pass filter. The transmitter unit can also have one or more transmitters emitting in a broad wavelength range and the receiver unit can have one or more receivers having one or more individual receivers, a transmitter being associated with each receiver. The signal can then be spatially and/or spectrally analyzed.

According to a favorable refinement of the sensor, the receiver unit can comprise one or more receivers. Preferably, as many receivers are provided in the receiver unit as transmitters in the transmitter unit.

The one or more receivers may be able to be chronologically synchronized with the transmitter unit and/or with one or more transmitters of the transmitter unit. A spectral, wavelength-related analysis of the received signal is thus possible.

Means may be associated with the one or more receivers, using which the light is detectable independently of wavelength. The means may be upstream elements, in particular filters and/or prisms. The receivers can also have receiver-specific properties, which allow at least predominantly wavelength-independent detection of the light in the desired wavelength range.

The light can also be spectrally analyzable by the one or more receivers. Receivers may be used here, whose receiver-specific properties allow a spectral analysis. Receivers as are used in digital color cameras are favorable, which are capable of associating an intensity and/or allow an intensity to be associated with each received wavelength over a large wavelength range through upstream so-called “Beyer patterns.”

In the method according to the invention for operating a sensor for detecting dirt and/or rain having at least one transmitter unit and at least one receiver unit as well as a test surface, an accumulation on the test surface is detected by light which is emitted by the transmitter unit and collected by the receiver unit. A signal received by a receiver of the receiver unit is analyzed as a function of its wavelength of the associated transmitter and/or its geometrical origin location of the associated transmission sources of the transmitter, at least two transmission sources of a transmitter being activated. This can be performed with a time delay or simultaneously, the difference in their geometrical position to a possible accumulation being exploited. If the transmission sources emit different wavelengths, the additional path of the light can also be exploited. If multiple receivers are provided, each receiver analyzes the signal of one transmitter. Each transmitter can have one or more transmission sources, and the receiver can also have one or more individual receivers, whose signals may be suitably combined.

One transmitter of the transmitter unit can emit a broadband signal having multiple wavelengths or at least two transmission sources of a transmitter of the transmitter unit, which are associated with a shared receiver of the receiver unit, can be operated offset in time to one another. Especially locally bounded, in particular transparent accumulations in the form of water droplets may thus be differentiated from flat light-opaque or light-damping accumulations such as dust and the like.

A variation of the light intensity of the received signal within one or more measurement cycles, for example, can be studied as a function of the wavelength and/or the geometrical location of the transmitter. This makes it easier to differentiate between accumulations of water and dirt.

If a critical value of the variation of the light intensity is exceeded, the presence of water as an accumulation can be recognized. In this case, if the sensor is used in a device having luminosity regulation, the luminosity is not to be adjusted, because no light-damping dirtying exists, but rather the sensor is merely wet.

If the variation of the light intensity falls below a critical value, e.g., within one measurement cycle or from measurement cycle to measurement cycle, the presence of dust or other dirt as an accumulation can be recognized. In this case, adjustment of the luminosity would be necessary. The dimension of the critical value can be fixed individually for a given system in each case. Thus, a variation in the range of at most 10% of the intensity may be viewed as noncritical, for example.

### BRIEF DESCRIPTION OF THE DRAWINGS

Further advantages and details of the invention are explained in greater detail hereafter on the basis of preferred exemplary embodiments described in the drawing, without the invention being restricted to these exemplary embodiments, wherein:

FIGS. 1a-c schematically show an explanation of propagation conditions of a light beam of a preferred sensor based on reflection with clean test surface (FIG. 1a) and as a function of an accumulation (FIGS. 1b, 1c);

FIGS. 2a, b schematically show an explanation of the propagation conditions of a light beam of a preferred sensor based on transmitted light with clean test surface (FIG. 2a) and water as an accumulation (FIG. 2b);

FIGS. 3a, b show a top view of a preferred sensor based on transmitted light having a transmitter which comprises a plurality of transmission sources (FIG. 3a) and additionally a receiver, which is formed from individual receivers (FIG. 3b).

### DETAILED DESCRIPTION OF THE PREFERRED EMBODIMENT

Functionally identically acting elements are identified using identical reference numerals in the figures.

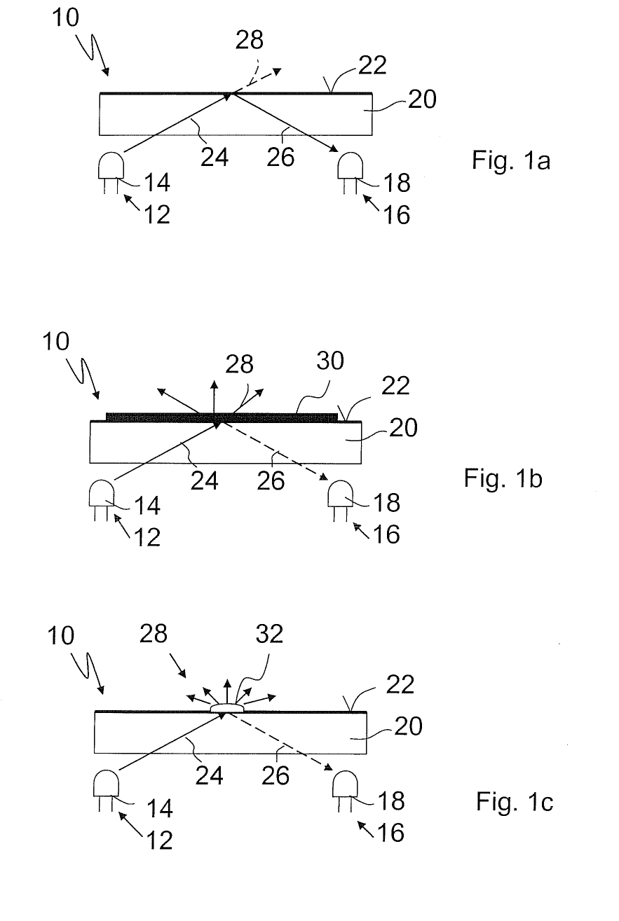

For better understanding of the invention, FIGS. 1a-1c explain schematic propagation conditions of testing light using light beams 24, 26, 28 of a preferred sensor 10 based on reflection with clean test surface 22 (FIG. 1a) and as a function of a light-damping, flat accumulation 30 of dust (FIG. 1b) and a local, transparent accumulation 32 of water (FIG. 1c). Such a sensor 10 having this geometry is frequently used as a rain sensor.

A transmitter unit 12 having a transmitter 14, preferably implemented as an LED, emits a light beam 24, which is reflected on the test surface 22 and is conducted as a reflected beam 26 to the receiver 18 of a receiver unit 16. The test surface 22 is implemented as the outer surface of a transparent test body 20, such as a window pane. Depending on the angle of incidence and/or wavelength of the light, the emitted light beam 24 is not totally reflected, but rather a part 28 is scattered outward (FIG. 1a). The intensity of the light beam 26 received by the receiver 18 is correspondingly reduced.

If accumulations 30 are provided, as shown in FIG. 1b as a layer of dust, the reflected light beam 26 is attenuated more strongly in its intensity. As a function of its thickness, the accumulation 30 implemented as a layer of dust absorbs more or less intensity of the light beam 24, a part of light beams 28 also being scattered outward. The accumulation 30 is typically distributed more or less homogeneously over a relatively large area. Changes in the thickness of the accumulation 30 occur relatively slowly; a layer of dust typically grows continuously with time. Appearances of age which may result in damping of the light intensity are also typically slowly changing procedures.

If the wavelength of the transmitter 14 is changed, the path of the testing light from the transmitter 14 to the receiver 18 thus changes. Nonetheless, hardly any variation of the light intensity of the light beam 26 is to be expected. If light is emitted from a position closely adjacent to the transmitter 14, hardly any change of the intensity received by the receiver 18 is also to be expected as a function of the position of the transmitter 14.

The situation with an accumulation 32 in the form of a water droplet is shown in FIG. 1c. At the boundary layer between water droplets and test surface 22, the index of refraction changes in a known manner. A part of the light exits outward from the test surface 22 as light beams 28 and is scattered by the water droplets. A lower light intensity is now incident on the receiver 18 than with clean test surface 22. In the extreme case, light is no longer incident on the receiver 18 if the water droplet is placed unfavorably and the light beam 24 is directly incident thereon, for example.

The test surface 22 does have an accumulation 32 in the form of water droplets, but this is not dirtying in the narrower meaning, such as mud or dust.

If the wavelength of the transmitter 14 is changed, a stronger variation of the light intensity of the received light beam 26 is to be expected because of the local delimitation of the water droplet than in the event of a dust layer. If light is emitted from a position closely adjacent to the transmitter 14, a stronger change of the intensity received by the receiver 18 is also to be expected as a function of the position of the transmitter 14, above all if the water droplet is narrowly limited. The light beam of a light source closely adjacent to the transmitter 14 would then no longer engage the water droplet or would be interfered with less thereby, and the receiver 18 would receive a greater signal.

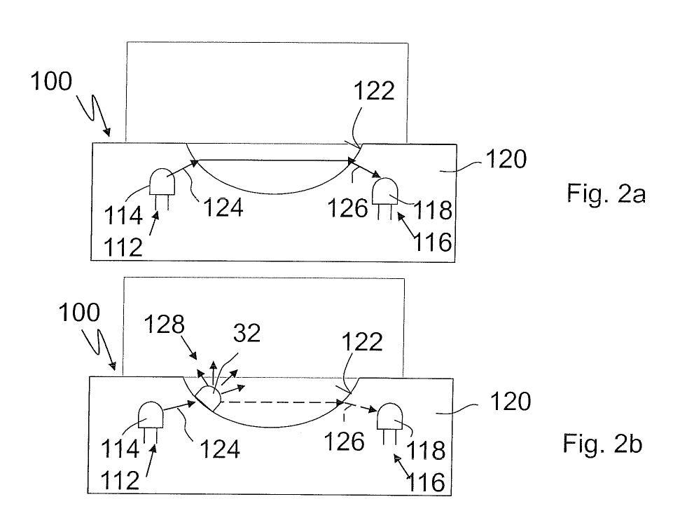

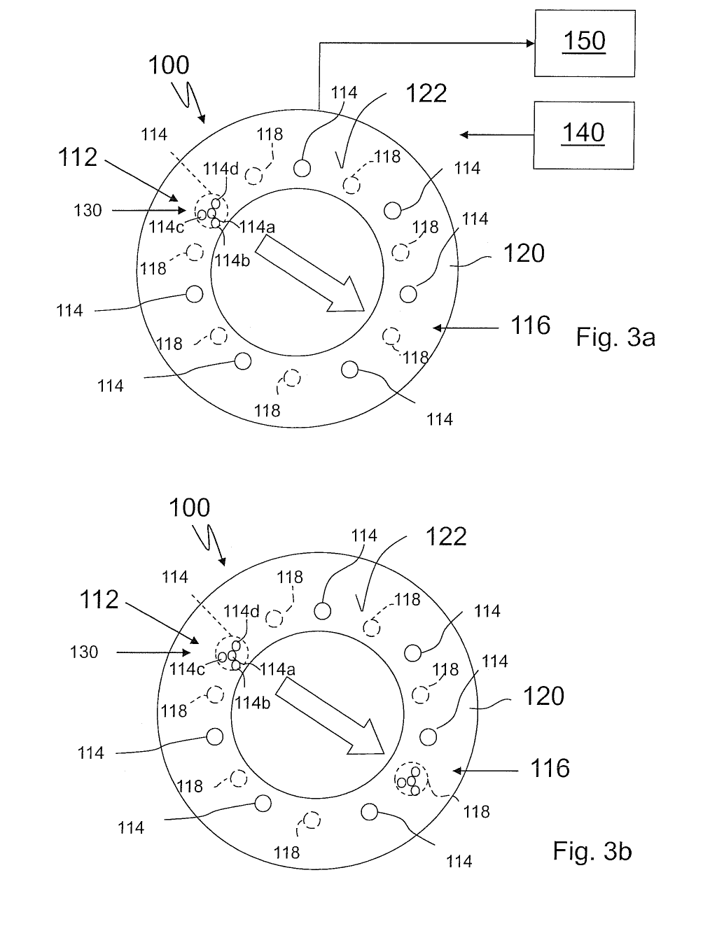

FIGS. 2a and 2b and 3a and 3b explain the conditions in a preferred sensor 100 based on transmitted light with clean test surface 122 (FIG. 2a) and with accumulations 32 in the form of a water droplet (FIG. 2b). The preferred embodiments shown of transmitter unit 112 and receiver unit 116 are also transferable correspondingly to a sensor based on reflection, however. The sensor 100 is shown in a top view in FIGS. 3a, 3b.

The sensor 100, which is shown in section, comprises a testing body 120, in which a transmitter unit 112 and a receiver unit 116 are situated, as well as a curved test surface 122, the test surface 122 comprising the light exit surface of the transmitter unit 112 and the light entry surface of the receiver unit 116. The transmitter unit 112 has at least one transmitter 114, preferably implemented as an LED, and is shown here having seven transmitters 114 as an example. The receiver unit 116 comprises at least one receiver 118, preferably implemented as a photodiode, and is shown here having seven receivers 118 as an example. Transmitters 114 and receivers 118 are situated alternately concentrically around the test surface 122, a receiver 118 following each transmitter 114 in the peripheral direction. One receiver 118 is thus diametrically opposite to each transmitter 114. The particular transmitter 114 is associated with the diametrically opposite receiver 118, which receives its signals and relays them to a schematically shown analysis unit 150. A unit 140 activates the transmitter unit 112 and the receiver unit 116.

Because the test surface 122 is curved (into the plane of the drawing in the figure), the light from the transmitter 114 passes through the test surface 122 twice before it reaches the receiver 118. The test surface 122 can even have a wavy structure as in DE 10 2004 038 422 B3 and the emitted light beams can pass through the test surface 122 correspondingly frequently.

It can also be seen here that the intensity of the received light 126 decreases or can unfavorably disappear entirely if the locally delimited accumulation 32 (FIG. 2b) is unfavorably situated in the beam path between transmitter 114 and receiver 118.

If dust accumulates, the received light intensity in the receiver 118 decreases proportionally to the dust thickness. In contrast, if water droplets are present as the accumulation 32, local variations of the received light intensity are to be expected, depending on where the water droplets accumulate. This is explained on the basis of the sensor 100 based on transmitted light in FIGS. 3a, 3b in a top view of the sensor 100. The same principle is also transferable to the sensor 10 based on reflection in FIG. 1.

The transmitter unit 112 comprises a plurality (seven here) of transmitters 114 situated concentrically in the circle around the test surface 122. Receivers 118 of the receiver unit 116 are also situated concentrically around the test surface 122 between the transmitters 114. A receiver 118 associated with this transmitter 114 is opposite to each transmitter 114.

One of the transmitters 114 is formed in one region 130 as an example by a group of closely adjacent further transmitters, which are referred to hereafter as transmission sources 114a, 114b, 114c, 114d. This group of transmission sources 114a, 114b, 114c, 114d is associated with a single shared receiver 118 of the receiver unit 116, which is opposite to the group in relation to the test surface 122, which is curved into the testing body 120, as indicated by a thick arrow.

The transmission sources 114a, 114b, 114c, 114d, which are preferably implemented as LEDs, each transmit at a different wavelength, which the preferably broadband receiver 118 can receive, according to a preferred refinement of the invention. However, alternatively or additionally, the other transmitters 114 formed from a single transmission source (light source) may also transmit at different wavelengths.

All of the transmitters 114 of the transmitter unit 112, or only some of the transmitters 114, may be formed by at least two or more transmission sources 114a, 114b, 114c, 114d.

Typically, the transmitters 114 are activated in one measurement cycle in chronological sequence in the peripheral direction around the test surface 122 by an activation unit 140, for example, at intervals of 100-200 ms, the signal of the particular diametrically opposite receiver 118 is measured, and the dirtying of the test surface 122 is deter mined therefrom, so that the test surface 122 is scanned all around once in one measurement cycle.

If an accumulation 32 implemented as water droplets is situated on a region 130 of the test surface 122 over the group of transmission sources 114a, 114b, 114c, 114d, a relatively abruptly occurring intensity change is displayed in the various receivers 118, both in a chronological aspect between sequential measurement cycles, when the water droplet hits for the first time, and also within a measurement cycle between the signals of the individual transmitters 114, when the testing beam between the further transmitters 114 and receivers 118 no longer engages the water droplet because of the geometric position thereof. In contrast, if dirt such as dust were accumulated, this dirt layer would grow with slow chronological variation and be spatially distributed rather homogeneously and correspondingly only cause a chronologically slow and spatially slight variation of the received signals.

Thus, the signal of the transmitter 114 received by the particular receiver 118 on the right and left adjacent to the area 130 having the accumulation 32 (FIG. 2b) is significantly different from the signal of the transmitter 114 in the region 130. The adjacent transmitters 114 do not detect the water droplet. If the transmission sources 114a, 114b, 114c, 114d emit different wavelengths, a variation of the received intensity is displayed over the wavelengths, because water absorbs in the infrared range and in the ultraviolet range and is transparent in the visible range. Wavelengths at which the optical properties of the water are significantly different are expediently used for the testing light.

Furthermore, the spatial offset of the closely adjacent transmission sources 114a, 114b, 114c, 114d to one another can possibly already be sufficient to cause a variation of the intensity of the signal received by the associated diametrically opposite receiver 118. If dust were accumulated on the test surface 122, the variation between the received signals of the transmission sources 114a, 114b, 114c, 114d would be less, and the variation between adjacent transmitters 114 would also be low, because experience has shown that dust covers the test surface 122 flatly.

A signal received by a receiver 118 of the receiver unit 116 can therefore be analyzed as a function of its wavelength and/or its geometric origin location of the particular associated transmitter 114 and/or the transmission sources 114a, 114b, 114c, 114d. Similarly to this configuration, the receivers 118 can alternatively or additionally also comprise a group of closely adjacent receivers, as shown in FIG. 3b. Only one of the receivers is constructed from individual receivers similarly to the transmission sources 114a, 114b, 114c, 114d in FIG. 3b. Two or more receivers 118 of the receiver 116 may also be implemented in this way. The individual receivers and the transmission sources 114a, 114b, 114c, 114d are distributed on a narrowly delimited area, which is well separated from adjacent transmitters 114 and receivers 118. The area is expediently slightly larger, expediently at most five times as large, preferably at most three times as large, particularly preferably at most twice as large as the total area of the services of the individual receivers and/or transmission sources 114a, 114b, 114c, 114d of the corresponding receiver 118 or transmitter 114.

The transmission sources 114a, 114b, 114c, 114d of the transmitter 114 of the transmitter unit 112 may preferably be operated chronologically offset to one another and the variation of the received signal may be studied as a function of the wavelength and/or the geometric location of the transmission sources 114a, 114b, 114c, 114d. Such an internal measurement cycle using all transmission sources 114a, 114b, 114c, 114d of a transmitter 114 can preferably be triggered if an irregular measurement value is observed in a regular measurement cycle, such as an outlier in the measured values. In a regular measurement cycle, all typical transmitters 114 and receivers 118 are active, e.g., having “normal” transmitters 114, which do not have transmission sources 114a, 114b, 114c, 114d. It can be provided that in the design of the transmitter 114 having multiple transmission sources 114a, 114b, 114c, 114d, normally only one transmission source, such as the central transmission source 114a is operated, and the other transmission sources 114b, 114c, 114d are only turned on as needed if an irregular measured value is detected. If multiple or all transmitters 114 are equipped with transmission sources 114a, 114b, 114c, 114d, it can correspondingly be provided that normally only one of the transmission sources 114a, 114b, 114c, or 114d of the particular transmitter 114 is operated at a time and the other transmission sources 114a, 114b, 114c, or 114d of the particular transmitter 114 are only turned on as needed. Alternatively, however, all transmission sources 114a, 114b, 114c, 114d of the transmitter 114 may be activated during every measurement cycle at different wavelengths and/or spatially offset. This may be performed similarly in a design of one or more receivers 118 as a group of two or more individual receivers, so that normally only one individual receiver of the corresponding receiver 118 is active and the other individual receivers are turned on as needed upon the occurrence of an irregular, noteworthy measured value of the light intensity or a noteworthy change of the light intensity. The measured value can then be subjected to a corresponding plausibility observation, which permits a differentiation between dust and water as the accumulation 30, 32, for example.

If a critical value of the variation of the intensity of the received light in the receiver 118 is exceeded, the presence of water as an accumulation 32 is recognized. In the event of coupling to luminosity regulation of vehicle lights, an adaptation of the luminosity of the vehicle lights can be dispensed with. If the variation falls below a critical value, the presence of dust as an accumulation 30 is recognized and an adaptation of the luminosity is performed as needed.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A sensor for detecting dirt and/or rain having at least one transmitter unit (12, 112) and at least one receiver unit (16, 116) as well as a test surface (22, 122), an accumulation (30, 32) on the test surface (22, 122) being detectable by a light beam (24, 26; 124, 126), which is emitted by the transmitter unit (12, 112) and absorbed by the receiver unit (16, 116), characterized in that
the transmitter unit (12, 112) includes a plurality of transmitters (14, 114), said plurality of transmitters including a plurality of transmission sources (114a, 114b, 114c, 114d) disposed adjacent each other,
said receiver unit (16, 116) including a receiver (18, 118) associated with each of said plurality of transmitters (14, 114),
wherein one of said plurality of transmitters (14, 114) emits at least two different wavelengths, which are detectable by its associated receiver (18, 118).

2. The sensor according to claim 1, characterized in that the at least one transmitter (14, 114) comprises at least two transmission sources (114a, 114b, 114c, 114d) having different wavelengths.

3. The sensor according to claim 2, characterized in that the transmission sources (114a, 114b, 114c, 114d) of the at least one transmitter (14, 114) are so closely adjacent that their radiation can be received by the particular receiver (18, 118) associated with the transmitter (14, 114).

4. A sensor for detecting dirt and/or rain having at least one transmitter unit (12, 112) and at least one receiver unit (16, 116) as well as a test surface (22, 122), an accumulation (30, 32) on the test surface (22, 122) being detectable by a light beam (24, 26; 124, 126), which is emitted by the transmitter unit (12, 112) and absorbed by the receiver unit (16, 116), characterized in that
the transmitter unit (12, 112) has at least two transmitters (14, 114), at least one of which comprises two or more locally closely adjacent transmission sources (114a, 114b, 114c, 114d),
a receiver (18, 118) of the receiver unit (16, 116) is associated with each transmitter (14, 114), and
the receiver (18, 118) has one or more individual receivers.

5. The sensor according to claim 4, characterized in that the light beams (24, 124) emitted by the transmitters (14, 114) have different wavelengths.

6. The sensor according to claim 4, characterized by a design as a transmitted light sensor having a curved test surface (122).

7. The sensor according to claim 4, characterized by a design as a reflection sensor having a planar test surface (22).

8. The sensor according to claim 4, characterized in that an analysis unit (150) is provided in order to analyze a wavelength-dependent intensity variation and/or a location-dependent intensity variation of the received light beams (26, 126).

9. The sensor according to claim 4, characterized in that the transmitter unit (12, 112) comprises light-emitting diodes as transmitters (14, 114) and transmission sources (114a, 114b, 114c, 114d).

10. The sensor according to claim 4, characterized in that the one or more individual receivers of a receiver (18, 118) of the receiver unit (16, 116) can be chronologically synchronized with the associated transmitters (14, 114) of the transmitter unit (12, 112).

11. The sensor according to claim 4, characterized in that the transmitter unit (12, 112) comprises at least one broadband transmitter (14, 114).

12. The sensor according to claim 11, characterized in that means are associated with the one or more individual receivers, using which the light is detectable independently of wavelength.

13. The sensor according to one of claims 12, characterized in that the light can be spectrally analyzed by the one or more individual receivers.

14. A method for operating a sensor (10, 100) for detecting dirt and/or rain having at least one transmitter unit (12, 112) and at least one receiver unit (16, 116) as well as a test surface (22, 122), an accumulation (30, 32) on the test surface (22, 122) being detected by a light beam (24, 26; 124, 126) which is emitted by the transmitter unit (12, 112) and absorbed by the receiver unit (16, 116), in particular according to one of the preceding claims, characterized in that a signal received by a receiver (18, 118) of the receiver unit (16, 116) is analyzed as a function of its wavelength from one or more transmitters (14, 114) and/or its geometrical origin location from multiple associated transmission sources (114a, 114b, 114c, 114d) of a transmitter (14, 114) of the transmitter unit (12, 112) and at least two transmission sources (114a, 114b, 114c, 114d) of a transmitter (14, 114) of the transmitter unit (12, 122), with which the receivers (18, 118) of the receiver unit (16, 116) are jointly associated, are activated.

15. The method according to claim 14, characterized in that a transmitter (14, 114) of the transmitter unit (12, 112) outputs a polychromatic signal.

16. The method according to claim 14, characterized in that a variation of the received signal is studied as a function of the wavelength and/or the geometrical location of the transmitter (114) and/or the transmission sources (114a, 114b, 114c, 114d).

17. The method according to claim 14, characterized in that normally only one transmission source (114a) is operated per transmitter (14, 114) and the further transmission sources (114b, 114c, 114d) of the transmitter (14, 114) are only turned on as needed if an irregular measured value is detected.

18. The method according to claim 14, characterized in that normally only one individual receiver is operated per receiver (18, 118) and the further individual receivers of the receiver (18, 118) are only turned on as needed if an irregular measured value is detected.

19. The method according to claim 14, characterized in that if a critical value of the variation of the received signal is exceeded, the presence of water as an accumulation (32) is recognized.

20. The method according to claim 14, characterized in that if the variation of the received signal falls below a critical value, the presence of dirt as an accumulation (30) is recognized.

21. A use of a sensor (10, 100) according to claim 1 in a system for luminosity regulation of vehicle lights.
